(19) United States
(12) Patent Application Publication
(10) Pub. No.: US 2015/0250273 A1
(43) Pub. Date: Sep. 10, 2015

(54) Jewelry Item With Cosmetic Container and Indicia

(71) Applicants: Marylisette Adams, Ponte Vedra Beach, FL (US); Katina Etheredge, Ponte Vedra Beach, FL (US)

(72) Inventors: Marylisette Adams, Ponte Vedra Beach, FL (US); Katina Etheredge, Ponte Vedra Beach, FL (US)

(21) Appl. No.: 14/180,141

(22) Filed: Mar. 5, 2014

(51) Int. Cl. A44C 9/00; A44C 17/00; A45D 40/22; G09F 23/00; A45D 40/00; A45D 40/18

(52) U.S. Cl. CPC A44C 9/0069; A45D 40/00; A45D 40/18; A45D 40/222; G09F 23/00; A44C 17/00; A45D 2040/0012

(57) ABSTRACT

A jewelry item, such as a ring, combines promotional indicia or artistic designs with a concealed cosmetic container. In some embodiments, the invention may be an item of casual or costume jewelry, for example a ring featuring a flexible plastic or rubber band, rather than a metallic one that features a decoratively shaped compartment on top to conceal the container. Inside the container is a cosmetic product, which in some embodiments may be a casually applied cosmetic product such as lip gloss. The exterior of the container is decorated with imitation or real gemstones of varying colors. The gemstones may be arranged in any artistic or decorative pattern or, in some embodiments, may be arranged to form promotional indicia. In particular, the colors and arrangement of the gemstones may be set to promote the indicia of an athletic team of choice.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of jewelry, and in particular to the field of jewelry items that include a container or accessible open space within. Jewelry items often feature concealed containers for holding any of a variety of items, including cosmetics; likewise, jewelry items are also well known that decoratively designed to feature promotional indicia or artistic multicolored designs. Heretofore unknown, however, are jewelry items that combine the signaling value of promotional indicia or artistic multicolor designs with a concealed container for cosmetics.

### SUMMARY OF THE INVENTION

Accordingly, the invention is a jewelry item, such as a ring, that combines promotional indicia or artistic designs with a concealed cosmetic container. In some embodiments, the invention may be an item of casual or costume jewelry, such as a ring featuring a flexible plastic or rubber band, rather than a metallic one that features a decoratively shaped compartment on top to conceal the container. Inside the container is a cosmetic product, which in some embodiments may be a casually applied cosmetic product such as lip gloss. The exterior of the container is decorated with imitation or real gemstones of varying colors. The gemstones may be arranged in any artistic or decorative pattern or, in some embodiments, may be arranged to form promotional indicia. In particular, the colors and arrangement of the gemstones may be set to promote the indicia of an athletic team of choice.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a top view of the first exemplary embodiment of the invention with its cosmetic container closed, displaying the ring band 1, container 2, cover 4, hinge 5, upper clasp 6, and decorative gemstones 9.

FIG. 2 shows top view of the first exemplary embodiment of the invention with its cosmetic container open, displaying the ring band 1, container 2, chamber 3, cover 4, upper clasp 6, lower clasp 7, cosmetic container 2, decorative gemstones 9, and mirror 10.

### DETAILED DESCRIPTION OF THE INVENTION

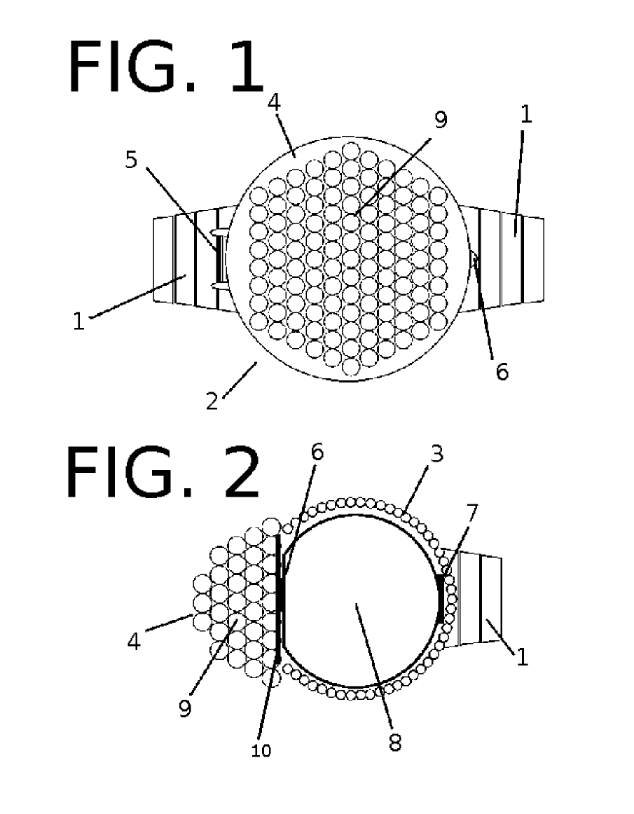

Referring now to the invention in more detail, the invention may take the form of any jewelry item with any type of concealed container, which may contain a cosmetic product and which may be decorated with any sort of promotional or artistic indicia. FIG. 1 and FIG. 2 show the first exemplary embodiment, which is a casual ring with a cosmetic container intended to contain lip gloss and being decorated on the exterior with gemstones arranged to create promotional or artistic indicia. Reference numbers are equivalent across the two figures.

In the first exemplary embodiment, a ring band 1 is provided. The ring band 1 may be made of stretchable rubber or plastic material or may be made of a traditional rigid plastic, metallic, or other material. Bonded, molded as a single piece, or otherwise affixed to the ring band 1 is a container 2. Alternative embodiments may provide a container 2 in the absence of a ring band, with another form of jewelry, such as a necklace, brooch, or bracelet in its place. The container 2 pictured is circular and dome-topped, however other shapes such as a flower may be used. The container 2 comprises a chamber 3 and cover 4 connected to each other by a hinge 5 and closed by an upper clasp 6 which snaps on to a lower clasp 7. The container 2 is made of similar material to the band 1, such as a stretchable plastic, rigid plastic, or traditional metallic material.

Inside the chamber 3 is a cosmetic container 8. The cosmetic container is removable and may be replaced or refilled. In some embodiments, the invention may be sold with a plurality of different types/colors/flavors of cosmetic container 8 which may be interchanged by the user according to preference. Opposite the chamber 3, the interior surface of the cover 4 may be covered by a mirror 10.

The exterior of the lower camber 3 and/or cover 4 is decorated with a plurality of decorative gemstones 9, which may be imitation or may be genuine, and which may be affixed by adhesive or other fastening means. Imitation gem stones 9 are preferred so as to reduce the manufacturing cost of the invention and to have greater control over color choices. The decorative gemstones 9 may be arranged in any combination or design of colors, in particular they may be arranged to form the coloration or indicia for a subject of promotion, such as an athletic team. For example, if the invention were to promote an Exampleball team, the Exampletown Exemplars, whose colors are blue and white and indicia form a white letter E against a blue background, then the invention could arrange either (1) any combination of blue and white gemstones, or (2) a combination of blue gemstones that surround a combination of blue gemstones that form the letter E. Alternatively, entirely different means of providing indicia other than the application of real or imitation gemstones; many such means are known in the prior art and any may be used.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

We claim:

1. A combined cosmetic container and article of jewelry comprising:
(a) an article of jewelry;
(b) a container;
(c) said container being affixed to said article of jewelry;
(d) said having a cover;
(e) an opening and reclosing means for opening and reclosing said cover;
(f) said cover being linked to said container by said opening and reclosing means for opening and reclosing said cover;
(g) a cosmetic container;
(h) said cosmetic container being removably located within said container;
(i) said cosmetic container containing a quantity of a cosmetic product;
(j) a plurality of decorative gemstones; and
(k) said decorative gemstones being affixed to at least one of the group of the exterior of said container, the exterior of said lid, or the exterior of said article of jewelry.

2. The combined cosmetic container and article of jewelry of claim 1 wherein said cosmetic product is lip gloss.

3. The combined cosmetic container and article of jewelry of claim 1 wherein said article of jewelry is a ring, and further comprises a ring band, said ring band being affixed to said container.

4. The combined cosmetic container and article of jewelry of claim 1 wherein said opening and reclosing means for opening and reclosing said cover comprises a hinge, an upper clasp, and a lower clasp, said hinge being configured to pivotably link said cover to the edge of said container, said upper clasp being affixed to the edge of said cover, said lower clasp being affixed to the edge of said container, and said upper clasp and said lower clasp being configured to engage with one another when said cover is in a closed position.

5. The combined cosmetic container and article of jewelry of claim 1 wherein said plurality of decorative gemstones are configured in a decorative pattern.

6. The combined cosmetic container and article of jewelry of claim 1 wherein said plurality of decorative gemstones substantially cover the exterior of said cover and over said container.

7. The combined cosmetic container and article of jewelry of claim 5 wherein said plurality of decorative gemstones substantially cover the exterior of said cover and over said container.

8. The combined cosmetic container and article of jewelry of claim 5 wherein said decorative pattern is configured to form a promotional indicia.

9. The combined cosmetic container and article of jewelry of claim 7 wherein said decorative pattern is configured to form a promotional indicia.

10. The combined cosmetic container and article of jewelry of claim 8 wherein said promotional indicia identifies a sports team.

11. The combined cosmetic container and article of jewelry of claim 9 wherein said promotional indicia identifies a sports team.

12. The combined cosmetic container and article of jewelry of claim 1 wherein the interior surface of said cover comprises a mirror.

13. The combined cosmetic container and article of jewelry of claim 3 wherein said cosmetic product is lip gloss.

14. The combined cosmetic container and article of jewelry of claim 4 wherein said cosmetic product is lip gloss.

15. The combined cosmetic container and article of jewelry of claim 4 wherein said article of jewelry is a ring, and further comprises a ring band, said ring band being affixed to said container.

16. The combined cosmetic container and article of jewelry of claim 4 wherein the interior surface of said cover comprises a mirror.

17. The combined cosmetic container and article of jewelry of claim 11 wherein the interior surface of said cover comprises a mirror.

18. The combined cosmetic container and article of jewelry of claim 15 wherein said article of jewelry is a ring, and further comprises a ring band, said ring band being affixed to said container.

19. The combined cosmetic container and article of jewelry of claim 18 wherein said plurality of decorative gemstones are configured in a decorative pattern.

20. The combined cosmetic container and article of jewelry of claim 17 wherein said plurality of decorative gemstones substantially cover the exterior of said cover and over said container.
